(19) United States
(12) Patent Application Publication
(10) Pub. No.: US 2007/0040845 A1
(43) Pub. Date: Feb. 22, 2007

(54) Pixel adaptive image color adjusting device and method thereof

(75) Inventors: Jin-ho Choo, Seoul (KR); Won-seok Ahn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/377,689

(22) Filed: Mar. 17, 2006

(30) Foreign Application Priority Data
Aug. 18, 2005 (KR) 10-2005-0075851

(51) Int. Cl. G09G 5/02

(52) U.S. Cl. 345/589

(57) ABSTRACT

A pixel adaptive image color adjusting device, including: a channel separation unit for separating an input image into a plurality of color channels by pixels; a conversion unit for converting the value of an adjustment target color channel based on an adjustment value for at least one of the plural color channels to be adjusted; a channel ratio calculation unit calculating a channel ratio of the adjustment target color channel before the conversion; a differentiator for obtaining a difference between a pre-conversion value and a post-conversion value of the adjustment target color channel; and a channel compensation unit for obtaining a compensating value for the adjustment target color channel by multiplying the difference obtained in the differentiator by the corresponding channel ratio, and obtaining a color channel value for expressing an image based on the compensating value. Therefore, an image color can be adjusted according to color channels adaptively to pixels and the image after color channel adjustment features a gradation of natural tones.

### CROSS-REFERENCE TO RELATED APPLICATIONS

This application claims priority from Korean Patent Application No. 10-2005-0075851, filed on Aug. 18, 2005, the entire content of which is incorporated herein by reference.

### BACKGROUND OF THE INVENTION

1. Field of the Invention

Apparatuses and methods consistent with the present invention relate in general to pixel adaptive image color adjusting, and more specifically, adjusting individual image colors for pixels using color channels and creating color-adjusted images having a gradation of natural tones.

2. Description of the Related Art

Korean Patent Application Laid-Open No. 2001-0113722 discloses a method of selective color control of digital video images.

Referring to FIG. 1, after receiving a digital video input image (S10), an input/output image grid is defined (S11). In operation S11, the input image is divided into chromatic components, such as CbCr or IQ, and designates them to the input/output image grid.

Then, a set of individual color look-up-tables (LUTs) for individual color control is defined (S12). Here, an individual color represents a linear combination of base colors of the input image. Then, a set of individual color control functions is defined for calculating values in the set of individual color LUTs (S13). Value to color control parameters, which include a plurality of tangents and a plurality of integer break points, in the set of individual color control functions are assigned (S14). Next, initial values are inserted (or substituted) into the set of individual color LUTs (S15). New values are determined and updated in the set of individual color LUTs in order to change an individual color of the digital video input image (S16). Finally, new chromatic components are calculated (S17), and the target image is output to be displayed (S18).

However, since the selective color control method is performed on Cb/Cr or I/Q chromatic components of a video input image, it is difficult to separate individual color channels for color control. Moreover, the method is mainly useful for processing Cb/Cr or I/Q chromatic components of a TV image signal, and is not adequate for processing JEPG or BMP images.

### SUMMARY OF THE INVENTION

The present invention provides a pixel adaptive image color adjusting device and method thereof, through which individual image colors are adjusted by color channels adaptively to pixels.

The present invention also provides a pixel adaptive image color adjusting device and method thereof, through which a color-adjusted image with a gradation of natural tones can be created.

According to an aspect of the present invention, there is provided a pixel adaptive image color adjusting device, including: a channel separation unit for separating an input image into a plurality of color channels by pixels; a conversion unit for converting the value of an adjustment target color channel based on an adjustment value for at least one of the plural color channels to be adjusted; a channel ratio calculation unit calculating a channel ratio of the adjustment target color channel before the conversion; a differentiator for obtaining a difference between a pre-conversion value and a post-conversion value of the adjustment target color channel; and a channel compensation unit for obtaining a compensating value for the adjustment target color channel by multiplying the difference obtained in the differentiator by the corresponding channel ratio, and obtaining a color channel value for expressing an image based on the compensating value.

The plurality of color channels may include red (R), green (G), blue (B), cyan (C), magenta (M) and yellow (Y) color channels.

The image color adjusting device may further include: a user control unit for receiving the adjustment value for at least one of adjustment target color channels among the R, G, B, C, M and Y color channels.

According to another aspect of the present invention, there is provided a pixel adaptive image color adjusting method, including the operations of: separating an input image into a plurality of color channels by pixels; receiving an adjustment value for at least one of the plurality of color channels to be adjusted, and converting the value of an adjustment target color channel based on the adjustment value; calculating a channel ratio of the adjustment target color channel before the conversion; obtaining a difference between a pre-conversion value and a post-conversion value of the adjustment target color channel, a compensating value for the adjustment target color channel by multiplying the difference obtained in the differentiator by the corresponding channel ratio, and a color channel value for expressing an image based on the compensating value.

The plurality of color channels may comprise red (R), green (G), blue (B), cyan (C), magenta (M) and yellow (Y) color channels.

In an exemplary embodiment, a channel ratio for each of the color channels is defined as follows: R color channel ratio (R_Ratio)={R_{TB}−max(G_{TB},B_{TB})}/(2ⁿ−1), G color channel ratio (G_Ratio)={G_{TB}−max(R_{TB},B_{TB})}/(2ⁿ−1), B color channel ratio (B_Ratio)={B_{TB}−max(R_{TB},G_{TB})}/(2ⁿ−1), C color channel ratio (C_Ratio)={C_{TB}−max(M_{TB}, Y_{TB})}/(2ⁿ−1), M color channel ratio (M_Ratio)={M_{TB}−max(Y_{TB},C_{TB})}/(2ⁿ−1), and Y color channel ratio (Y_Ratio)={Y_{TB}−max(C_{TB},M_{TB})}/(2ⁿ−1), wherein n denotes the number of bits of a color channel value, R_{TB}, G_{TB}, B_{TB}, C_{TB}, M_{TB}, Y_{TB} denote the R, G, B, C, M and Y color channel values before being converted, and max(X1_{TB},X2_{TB}) denotes greater one between the X1 color channel value and the X2 color channel value before being converted.

In an exemplary embodiment, the color channel value for expressing an image is obtained based on the following formulas: R color channel value=R_{TB}+D^{R}+w_{Y}×D^{Y}+(1−w_{M})×D^{M}, G color channel value=G_{TB}+D^{G}+w_{C}×D^{C}+(1−w_{Y})×D^{Y}, and B color channel value=B_{TB}+D^{B}+w_{M}×D^{M}+(1−w_{C})×D^{C}, wherein D is obtained by multiplying a difference between corresponding color channel values before and after being converted by a corresponding channel ratio, and w_{C}, w_{M}, and w_{Y} are weights between 0 and 1, 0≦w_{C}, w_{M}, and w_{Y}≦1.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a flow chart explaining a method of selective color control of a digital video image, according to a related art;

FIG. 2 is a functional block diagram of the configuration of an image processing apparatus provided with a color adjusting device according to an exemplary embodiment of the present invention;

FIG. 3 graphically illustrates the distribution of color values in the RGB domain;

FIG. 4 graphically illustrates channel ratio curves of color channels;

FIG. 5 is a flow chart explaining a color adjusting method according to an exemplary embodiment of the present invention; and

FIG. 6 illustrates an RGB color cube.

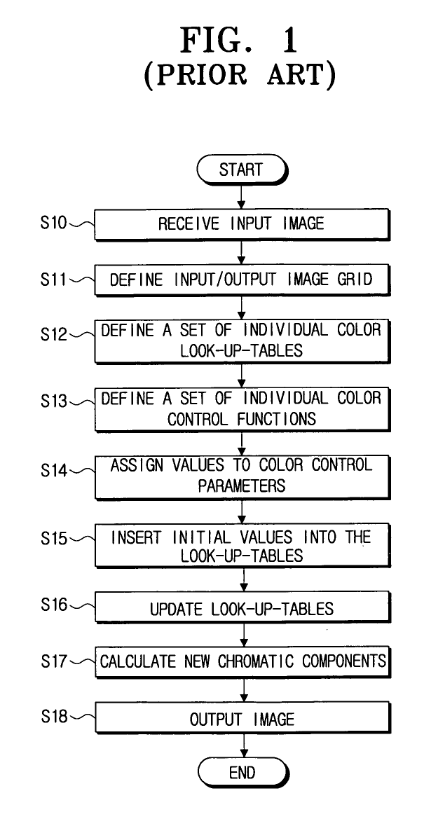

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings.

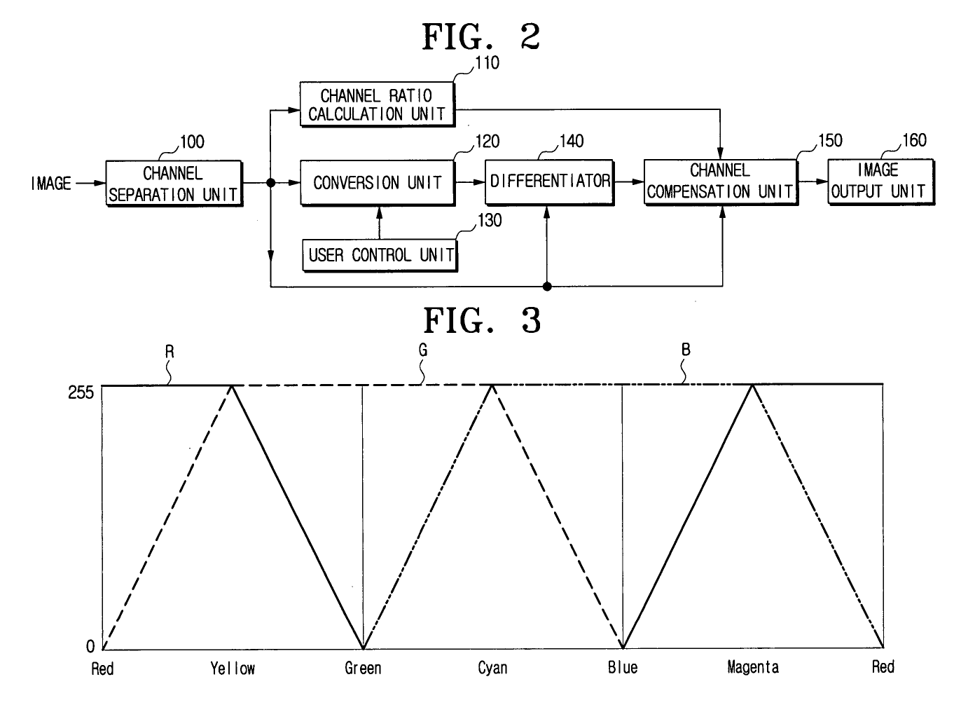

FIG. 2 is a functional block diagram of the configuration of an image processing apparatus provided with a color adjusting device according to an exemplary embodiment of the present invention.

The color adjusting device includes a channel separation unit 100, a channel ratio calculation unit 110, a conversion unit 120, a differentiator 140, and a channel compensation unit 150. The color adjusting device may further include a user control unit 130 if desired.

The channel separation unit 100 separates an input image into a plurality of color channels by pixels. In detail, the channel separation unit 100 separates each pixel of an image into a plurality of color channels in order to control a color channel a user wants to adjust (hereinafter, it will be referred to as an ‘adjustment target color channel’) independently. Each pixel of an image is expressed as a combination of Red, Green and Blue color channels in the RGB domain, and a combination of Cyan, Magenta and Yellow color channels in the CMY domain. Therefore, the plural color channels include three primary color channels (Red, Green, and Blue) and their complementary color channels (Cyan, Magenta, and Yellow).

The user control unit 130 receives an adjustment value for at least one of adjustment target color channels among the plural color channels. That is, the user control unit 130 receives from the user an adjustment value for one of the R, G, B, C, M and Y color channels to adjust an image color according to the user's preference.

The conversion unit 120 converts the value of an adjustment target color channel based on the adjustment value provided by the user control unit 130. Here, a predetermined mapping function may be used for the conversion.

The channel ratio calculation unit 110 calculates a channel ratio that each adjustment target color channel occupies in a corresponding pixel, before the conversion unit 120 converts the adjustment target color channels.

The differentiator 140 obtains a difference between a pre-conversion value and a post-conversion value of an adjustment target color channel.

The channel compensation unit 150 obtains a compensating value for an adjustment target color channel by multiplying the difference obtained in the differentiator 140 by a corresponding channel ratio. Therefore, according to an exemplary embodiment of the present invention, instead of applying the mapping function in a batch manner, image color adjustment is executed in consideration of the ratio the adjustment target color channel occupies in each pixel of an image so that the image may look more natural. For example, in a case where the user inputs an adjustment value for the R color channel to the user control unit 130 so as to adjust the R color channel, a pixel having a relatively high R color channel value is subjected more to an influence of adjustment than a pixel having a relatively low R color channel value.

An image output unit 160 of the image processing apparatus in FIG. 2 combines color channel values of an image, which are objected by the channel compensation unit 150, and outputs the resulting image.

The following now explains in detail how the channel calculation unit 110 calculates a channel ratio.

FIG. 3 shows the distribution of color values in the RGB domain. As aforementioned, each pixel of an image can be expressed as the combination of R, G and B color channels in the RGB domain. In particular, FIG. 3 illustrates a case where a color channel value is expressed with 8 bits, so that a color channel value has a value between 0 and 255 (=2⁸−1). For example, suppose that the value for the R color channel is 255 and the value for the G color channel is 0. Then, a corresponding pixel thereof is expressed in red. In another example, suppose that the value for the R color channel is 255 and the value for the G color channel gradually increased from 0 to 255. Then, a corresponding pixel thereof is expressed in yellow. At this time, the value for the B color channel is considered to be related to the brightness of a corresponding pixel's color. Therefore, as shown in FIG. 3, one can conclude that the saturation of each pixel's color is influenced by two out of R, G and B color channels in the RGB domain. Similarly, the saturation of each pixel's color is influenced by two out of C, M and Y color channels in the CMY domain.

Thus, in the case of expressing a color channel value with n bit, the ratio the R color channel occupies in each pixel can be defined as follows:

R color channel ratio (R_Ratio)={R_{TB}−max(G_{TB},B_{TB})}/(2ⁿ−1) wherein, n denotes the number of bits of a color channel value, R_{TB} denotes the R color channel value of a corresponding pixel before it is converted by the conversion unit 120, and max(G_{TB},B_{TB}) denotes a greater one between the G color channel value and the B color channel value before they are converted. That is, the R color channel ratio is a ratio that shows a relationship between an influence of the R color channel and an influence of the other channels upon the saturation of a corresponding pixel's color.

Similar to the R color channel ratio, the other color channel ratios can be defined as follows:
G color channel ratio (G_Ratio)={G_{TB}−max(R_{TB},B_{TB})}/(2ⁿ−1)
B color channel ratio (B_Ratio)={B_{TB}−max(R_{TB},G_{TB})}/(2ⁿ−1)
C color channel ratio (C_Ratio)={C_{TB}−max(M_{TB},Y_{TB})}/(2ⁿ−1)
M color channel ratio (M_Ratio)={M_{TB}−max(Y_{TB},C_{TB})}/(2ⁿ−1)
Y color channel ratio (Y_Ratio)={Y_{TB}−max(C_{TB},M_{TB})}/(2ⁿ−1)

Descriptions of parameters are omitted here because they are fundamentally the same as those in the formula for the R color channel ratio. Here, each color channel ratio has a value between −1 and 1, for example.

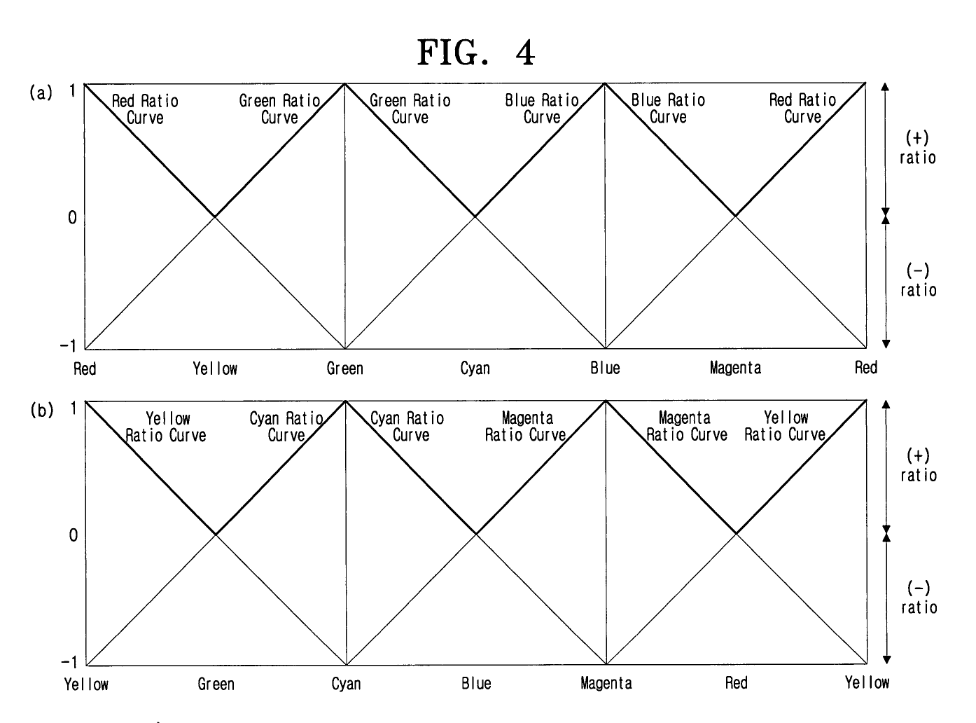

FIG. 4 illustrates color channel ratios defined by the above formulas. For instance, FIG. 4(a) illustrates channel ratio curves for R, G and B color channels, and FIG. 4(b) illustrates channel ratio curves for C, M and Y color channels. As in the example of FIG. 3, suppose that the value for the R color channel is 255 and the value for the G color channel is 0. Substituting these values to the above formulas yields 1 for the R color channel ratio and −1 for the G color channel ratio. At this time, a corresponding pixel is expressed in red. Meanwhile, in a case where the value for the R color channel is 255 and the value for the G color channel is also 255, both the R color channel ratio and the G color channel ratio are 0. At this time, a corresponding pixel is expressed in yellow.

The following now explains how the channel compensation unit 150 obtains a color channel value for expressing an image. As the image output unit 160 outputs an image by combining R, G and B colors, the channel compensation unit 150 calculates a value for each R, G and B color channel. An output value of the R color channel is defined as follows:
R color channel value=R_{TB}+D^{R}+w_{Y}×D^{Y}+(1−w_{M})×D^{M}

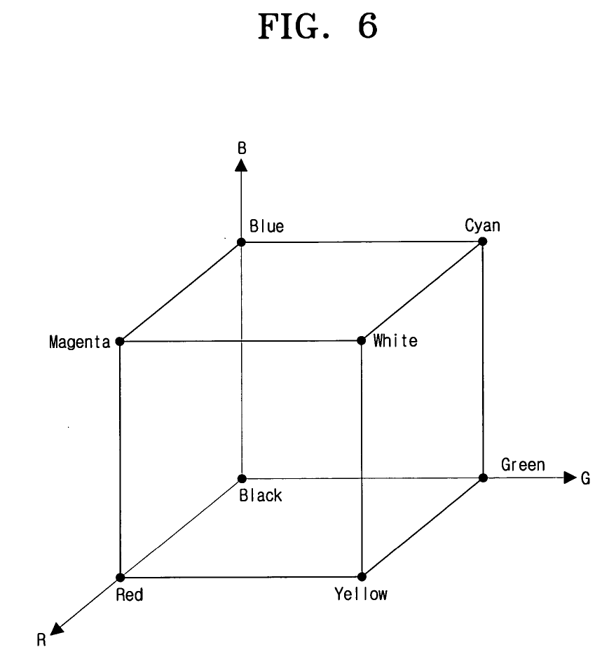

The output value of the R color channel is obtained by adding a multiplication result D^{R}, which is obtained by multiplying a difference value provided from the differentiator 140 by a channel ratio provided from the channel ratio calculation unit 110, to an R color channel value R^{TB} before being converted by the conversion unit 120. According to the present invention, instead of applying the mapping function in a batch manner, image color adjustment is executed in consideration of the ratio the adjustment target color channel occupies in each pixel of an image so that the image may look more natural. In a case where the user inputs adjustment values for CMY color channels, as can be seen in the RGB color cube of FIG. 6, the M color channel value and the Y color channel value are related to the R color channel value. This is why w_{Y}×D^{Y}+(1−w_{M})×D^{M} is added to the output value of the R color channel. Here, w_{Y} and (1−w_{M}) are weights of the Y color channel and the M color channel, respectively, which influence the R color channel. For example, weights may be 0.5.

Similar to the output value of the R color channel, output values of the G and B color channels can be defined as follows:
G color channel value=G_{TB}+D^{G}+w_{C}×D^{C}+(1−w_{Y})×D^{Y}
B color channel value=B_{TB}+D^{B}+w_{M}×D^{M}+(1−w_{C})×D^{C}
wherein, w_{C} and (1−w_{Y}) are weights of the C color channel and the Y color channel, respectively, which influence the G color channel; and w_{M} and (1−w_{C}) are weights of the M color channel and the C color channel, respectively, which influence the B color channel. Here, w_{C}, w_{M} and w_{Y} are real numbers between 0 and 1. As can be seen in the RGB color cube of FIG. 6, the C color channel value is related to the G and B color channel values. Hence, a sum of two weights w_{C} and (1−w_{C}), each indicating an influence of the C color channel value on the G color channel and the B color channel, becomes 1. Likewise, a sum of two weights (1−w_{M}) and w_{M}, each indicating an influence of the M color channel value on the R color channel and the B color channel, becomes 1. Moreover, a sum of two weights w_{Y} and (1−w_{Y}), each indicating an influence of the Y color channel value on the R color channel and the G color channel, becomes 1.

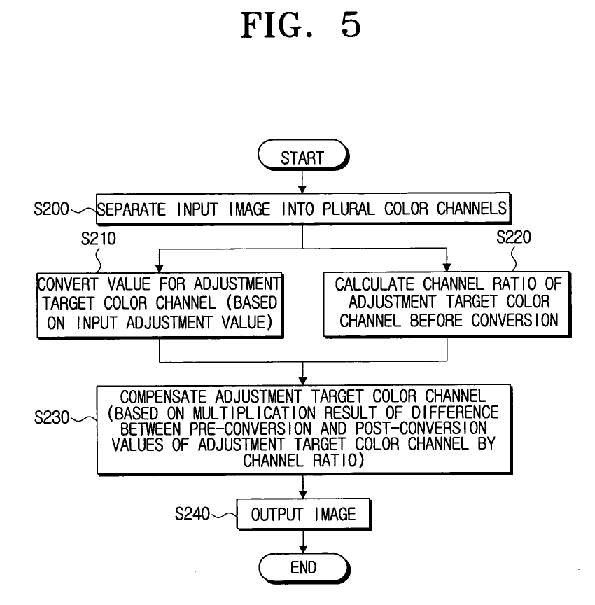

FIG. 5 is a flow chart explaining a color adjusting method according to an exemplary embodiment of the present invention.

In operation S200, an input image is separated into a plurality of color channels by pixels. Each pixel of an image is separated into a plurality of color channels in order to control an adjustment target color channel independently. The plural color channels include three primary color channels (Red, Green, and Blue) and their complementary color channels (Cyan, Magenta, and Yellow).

In operation S210, the value of an adjustment target color channel is converted based on a user input adjustment value for the adjustment target color channel. For instance, an image color can be adjusted according to the user's preference by receiving from the user an adjustment value for one of the R, G, B, C, M and Y color channels. Here, the conversion takes place by using a predetermined mapping function.

In operation S220, a channel ratio is calculated for each adjustment target color channel before being converted. In other words, a channel ratio that each adjustment target color channel occupies in a corresponding pixel is calculated. The channel ratio calculation method was previously explained.

In operation S230, a difference between a pre-conversion value and a post-conversion value of an adjustment target color channel is obtained, and a compensating value for the adjustment target color channel is obtained by multiplying the difference obtained in operation S220 by a corresponding channel ratio. Based on this compensating value, a color channel value for expressing an image is obtained later. According to an exemplary embodiment of the present invention, instead of outputting the converted value in operation S210 in a batch manner, an image color adjustment is executed in consideration of the ratio the adjustment target color channel occupies in each pixel of an image so that the image may look more natural. The method of obtaining a color channel value for expressing an image was previously explained.

In operation S240, an image is output by combining the color channel values provided in operation S230.

As explained so far, the color adjusting device and method of the exemplary embodiments of the present invention can be advantageously used for adjusting an image color according to color channels, adaptively to pixels. In addition, an image after color channel adjustment features a gradation of natural tones.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image color adjusting device comprising:
a channel separation unit which separates a pixel of an input image into a plurality of color channels;
a conversion unit which converts a value of an adjustment target color channel based on an adjustment value for at least one of the color channels;
a channel ratio calculation unit which calculates a channel ratio of the adjustment target color channel before the value is converted;
a differentiator which obtains a difference between a pre-conversion value and a post-conversion value of the adjustment target color channel; and
a channel compensation unit which obtains a compensating value for the adjustment target color channel by multiplying a difference obtained in the differentiator by the channel ratio, and obtains a color channel value which expresses an image based on the compensating value.

2. The device of claim 1, wherein the plurality of color channels comprise red (R), green (G), blue (B), cyan (C), magenta (M) and yellow (Y) color channels.

3. The device of claim 2 further comprising a user control unit which receives the adjustment value for the adjustment target color channel which is among the R, G, B, C, M and Y color channels.

4. The device of claim 2, wherein a channel ratio for each of the color channels is defined as:
R color channel ratio (R_Ratio)={R_{TB}−max(G_{TB},B_{TB})}/(2ⁿ−1)
G color channel ratio (G_Ratio)={G_{TB}−max(R_{TB},B_{TB})}/(2ⁿ−1)
B color channel ratio (B_Ratio)={B_{TB}−max(R_{TB},G_{TB})}/(2ⁿ−1)
C color channel ratio (C_Ratio)={C_{TB}−max(M_{TB},Y_{TB})}/(2ⁿ−1)
M color channel ratio (M_Ratio)={M_{TB}−max(Y_{TB},C_{TB})}/(2ⁿ−1)
Y color channel ratio (Y_Ratio)={Y_{TB}−max(C_{TB},M_{TB})}/(2ⁿ−1)
wherein, n denotes a number of bits of a color channel value; R_{TB}, G_{TB}, B_{TB}, C_{TB}, M_{TB}, Y_{TB} denote the R, G, B, C, M and Y color channel values before being converted; and max(X1_{TB},X2_{TB}) denotes a greater one of an X1 color channel value and an X2 color channel value before being converted.

5. The device of claim 4, wherein the channel compensation unit obtains a color channel value for expressing an image based on the following formulas:
R color channel value=R_{TB}+D^{R}+w_{Y}×D^{Y}+(1−w_{M})×D^{M}
G color channel value=G_{TB}+D^{G}+w_{C}×D^{C}+(1−w_{Y})×D^{Y}
B color channel value=B_{TB}+D^{B}+w_{M}×D^{M}+(1−w_{C})×D^{C}
wherein, D is obtained by multiplying a difference between corresponding color channel values before and after being converted by a corresponding channel ratio, and w_{C}, w_{M}, and w_{Y} are weights defined by 0≦w_{C}, w_{M}, and w_{Y}≦1.

6. The device of claim 1, wherein the channel separation unit separates each pixel of the input image into the plurality of color channels.

7. An image color adjusting method, comprising:
separating a pixel of an input image into a plurality of color channels;
receiving an adjustment value for at least one of the plurality of color channels, and converting a value of an adjustment target color channel based on the adjustment value;
calculating a channel ratio of the adjustment target color channel before the converting;
obtaining a difference between a pre-conversion value and a post-conversion value of the adjustment target color channel;
obtaining a compensating value for the adjustment target color channel by multiplying the difference obtained in the differentiator by the corresponding channel ratio; and
obtaining a color channel value for expressing an image based on the compensating value.

8. The method of claim 7, wherein the plurality of color channels comprise red (R), green (G), blue (B), cyan (C), magenta (M) and yellow (Y) color channels.

9. The method of claim 8, wherein a channel ratio for each of the color channels is defined:
R color channel ratio (R_Ratio)={R_{TB}−max(G_{TB},B_{TB})}/(2ⁿ−1)
G color channel ratio (G_Ratio)={G_{TB}−max(R_{TB},B_{TB})}/(2ⁿ−1)
B color channel ratio (B_Ratio)={B_{TB}−max(R_{TB},G_{TB})}/(2ⁿ−1)
C color channel ratio (C_Ratio)={C_{TB}−max(M_{TB},Y_{TB})}/(2ⁿ−1)
M color channel ratio (M_Ratio)={M_{TB}−max(Y_{TB},C_{TB})}/(2ⁿ−1)
Y color channel ratio (Y_Ratio)={Y_{TB}−max(C_{TB},M_{TB})}/(2ⁿ−1)
wherein, n denotes a number of bits of a color channel value; R_{TB}, G_{TB}, B_{TB}, C_{TB}, M_{TB}, Y_{TB} denote the R, G, B, C, M and Y color channel values before being converted; and max(X1_{TB},X2_{TB}) denotes a greater one of an X1 color channel value and an X2 color channel value before being converted.

10. The method of claim 9, wherein the color channel value for expressing an image is obtained based on the following formulas:
R color channel value=R_{TB}+D^{R}+w_{Y}×D^{Y}+(1−w_{M})×D^{M}
G color channel value=G_{TB}+D^{G}+w_{C}×D^{C}+(1−w_{Y})×D^{Y}
B color channel value=B_{TB}+D^{B}+w_{M}×D^{M}+(1−w_{C})×D^{C}
wherein, D is obtained by multiplying a difference between corresponding color channel values before and after being converted by a corresponding channel ratio, and w_{C}, w_{M}, and w_{Y} are weights defined by 0≦w_{C}, w_{M}, and w_{Y}≦1.

11. The method of claim 7, wherein the separating separates each pixel of the input image into the plurality of color channels.
